(19) United States
(12) Patent Application Publication
(10) Pub. No.: US 2011/0237368 A1
(43) Pub. Date: Sep. 29, 2011

(54) Stitch-free Football Structure and Method of Manufacturing the Same

(75) Inventor: Mei Sun LIN, Taipei (TW)

(73) Assignee: Long Way Enterprise Co., Ltd., Taipei (TW)

(21) Appl. No.: 12/731,124

(22) Filed: Mar. 24, 2010

(51) Int. Cl. A63B 41/10; A63B 45/00; B29C 63/22

(52) U.S. Cl. 473/603; 156/156

(57) ABSTRACT

A stitch-free football structure includes a ball bladder formed by providing a yarn layer on an outer surface of an inflatable bladder and a glue layer on an outer side of the yarn layer, and a prolate-spheroidal structure formed by adjoining curved panels having configuration corresponding to the ball bladder and glued to an outer side of the glue layer; and a lacing-shaped patch glued to a seam between two adjoining curved panels to meet a required football configuration. In a method of manufacturing the stitch-free football structure, a plurality of curved panels is prepared in advance by hot press molding, and the curved panels are joined and attached to a ball bladder by gluing. Thus, the procedures for manufacturing a football are simplified, the bad yield in manufacturing is reduced, and the produced football is more durable for use, has more precise dimensions, and beautiful and even exterior appearance.

### FIELD OF THE INVENTION

The present invention relates to a stitch-free football structure and a method of manufacturing the same; and more particularly, to an improved football structure and a method of manufacturing the same, with which panels for forming a football are pre-formed and then glued to an outer surface of a ball bladder, so that the football can be manufactured in upgraded efficiency and has increased durability.

### BACKGROUND OF THE INVENTION

The manufacturing of a standard football involves many procedures. Please refer to FIG. 1 that illustrates the procedures for manufacturing a conventional football. As shown, in a first step, cut pieces of interior lining 11 and outer cover layer 12 having a proper configuration are provided by way of punching. The interior lining 11 and the outer cover layer 12 are superposed on each other and primarily sewed together to provide a panel 13. A plurality of panels 13 is sewed together with the outer cover layers 12 facing inward, so as to provide a ball cover layer 15 having a lacing hole 14. Then, the ball cover layer 15 is turned inside-out for all sewed edges 16 to face inward. The ball cover layer 15 is adjusted to a required shape and a ball bladder 17 is inserted through the lacing hole 14 into the ball cover layer 15, and then, the ball bladder 17 is primarily inflated to adjust the ball cover layer 15 for the same to have a configuration of a football. Then, the lacing hole 14 on the ball cover layer 15 is closed using a thick lace 18, and the ball bladder 17 is fully inflated to adjust the configuration of the football again. Finally, the produced football is tested to see whether it meets the required standards.

Therefore, as shown in FIGS. 1 and 2, a standard football structure includes an innermost ball bladder 17, a ball cover layer 15 located outside the ball bladder 17 and having a plurality of panels 13 each being formed from superposed and sewed-up interior lining 11 and outer cover layer 12, and a lacing 19 formed at the closed lacing hole 14 on the ball cover layer 15 using the thick lace 18.

With the conventional procedures for manufacturing a football, when the ball cover layer 15 is turned inside out, the sewed edges 16 formed between any two adjoining panels 13 will be sandwiched between the ball cover layer 15 and the ball bladder 17. Since the sewed edges 16 have a thickness larger than that at other areas of the ball cover layer 15, the produced football would have reduced roundness. Further, during the fierce football game, the sewed edges 16 would constantly abrade the outer surface of the ball bladder 17 to cause quick wearing and breaking at the portions of the ball bladder 17 in contact with the sewed edges 16. Therefore, the durability of the football is undesirably reduced.

Besides, according to the conventional football manufacturing procedures, the sewing of the panels 13 together to form the ball cover layer 15 largely relies on the worker's personal skill. Panels 13 having been inaccurately sewed together would result in a produced football without a required configuration. Some other defects frequently occurring in the conventional football manufacturing procedures include: (1) unable to fully turn the ball cover layer inside out, particularly at two slightly pointed ends thereof to thereby form two dented ends of the football; and (2) sewed edges 16 with too large or too small size are formed to result in non-uniform ball radius. Further, it is time-consuming to sew the panels together one by one. Thus, sewing the panels to form the ball cover layer is obviously disadvantageous in terms of the football manufacturing.

In summary, the manufacturing of a conventional football largely relies on workers than machines. Footballs manufactured by workers having different skill levels tend to have different quality levels, and therefore, high quality control cost is required. In addition, the sewed edges 16 inside the football would reduce the completeness of the exterior appearance of the football and reduce the durability of the ball bladder 17. Therefore, it is desirable to improve the conventional football and the manufacturing procedures thereof.

### SUMMARY OF THE INVENTION

A primary object of the present invention is to provide a stitch-free football structure, in which panels are glued to an outer surface of a ball bladder to avoid the forming of sewed edges, enabling the produced football to have complete exterior appearance and increased roundness. Without the sewed edges, the football can have an even outer surface to minimize any adverse influence on the football game, and the ball bladder is not subject to abrasion by the sewed edges to thereby have extended useable life.

Another object of the present invention is to provide a method of manufacturing a stitch-free football structure, in which all the sewing procedures are omitted to largely reduce the requirement for workers' personal skill in manufacturing a football and to reduce man-made errors in the manufacturing process, allowing the football to be manufactured on a production line.

To achieve the above and other objects, one aspect of the present invention provides a stitch-free football structure including an inflatable bladder; a yarn layer provided on an outer surface of the inflatable bladder; a glue layer provided on an outer side of the whole yarn layer; a prolate-spheroidal structure formed by a plurality of adjoining curved panels and glued to an outer side of the glue layer; and a lacing-shaped patch. The curved panels are curved pieces having a curvature corresponding to a configuration of the inflatable bladder, and the curved pieces are joined along adjoining edges thereof using a gluing material, so that the prolate-spheroidal structure formed by the curved panels is stitch-free. The lacing-shaped patch is glued to a seam between two adjoining curved panels. And, the glue layer is formed using an emulsion or polyurethane (PU).

The lacing-shaped patch is integrally formed by injection-molding or pour-molding to resemble a lacing structure on a conventional football, and accordingly, includes an elongated main body for extending along the seam and a plurality of parallel branches, each of which is symmetrically extended outward from two lateral sides of the main body. Since the lacing-shaped patch is glued onto the seam between two adjoining panels, a lot of time for closing a lacing hole using a thick lace as in the conventional way of manufacturing a football can be saved.

In a preferred embodiment of the present invention, each of the curved panels includes a flat inner layer for gluing to the glue layer and a flat outer layer attached to an outer side of the inner layer. The inner layer and the outer layer are superposed on each other and then bent to form a curved panel matching the configuration of the ball bladder.

In another preferred embodiment of the present invention, each of the curved panels includes a three-dimensional (3D) inner layer for contacting with and attaching to the glue layer and a 3D outer layer attached to an outer side of the inner layer; the 3D inner layer has two opposite pointed ends forming two inward bent portions, and the 3D outer layer is formed by hot press molding.

In a preferred embodiment of the present invention, the yarn layer is a prolate-spheroidal structure formed by knitted synthetic twisted yarns into a configuration corresponding to that of the inflatable bladder. In another preferred embodiment of the present invention, the yarn layer is a prolate-spheroidal structure formed by sewing multiple pieces of cloth fabric together to provide a configuration corresponding to that of the inflatable bladder. And, in a further preferred embodiment of the present invention, the yarn layer is a substantially prolate-spheroidal structure formed by overlapping and gluing a plurality of cloth fabric pieces onto the outer surface of the inflatable bladder.

To achieve the above and other objects, another aspect of the present invention provides a method of manufacturing a stitch-free football structure. The method includes the following steps:

producing an inflatable bladder matching the shape of a football; forming a yarn layer on an outer surface of the inflatable bladder and inflating the bladder, so as to set the inflatable bladder and the yarn layer to a required shape for the yarn layer to fully bear on the inflatable bladder; evenly applying glue over the whole yarn layer and allowing the glue to fill up all voids in the yarn layer and form a glue layer, and heat-drying the glue layer to provide a ball bladder having a smooth outer surface; producing a plurality of curved panels corresponding to the configuration of the ball bladder and producing a lacing-shaped patch corresponding to a curvature of the curved panels; gluing the curved panels to the outer surface of the ball bladder, and gluing the lacing-shaped patch to a seam between two adjoining curved panels to obtain a complete prolate-spheroidal structure; and positioning the prolate-spheroidal structure in a heating device to proceed with a ball curvature and shape adjustment procedure, so as to obtain a stitch-free football with high roundness.

According to a preferred embodiment of the present invention, the lacing-shaped patch is integrally formed by injection-molding or pour-molding; and each of the curved panels is produced by preparing a cut piece of inner layer and a cut piece of outer layer corresponding to the configuration of the inflatable bladder, superposing the inner and the outer layer on each other, and processing the superposed inner and outer layers to produce the curved panels matching the curved surface of a football.

According to another preferred embodiment of the present invention, the curved panels are further positioned in a heating device and pressed, so that two opposite pointed ends of the curved panels form two inward bent portions.

According to a preferred embodiment of the present invention, the steps for forming the yarn layer include knitting synthetic twisted yarns into a prolate-spheroidal net structure having an opening and a configuration matching that of the inflatable bladder; inserting the inflatable bladder into the prolate-spheroidal net structure via the opening thereof; and sewing or binding up the opening.

According to another preferred embodiment of the present invention, the steps for forming the yarn layer include preparing a plurality of cut pieces of cloth corresponding to the configuration of the inflatable bladder; sewing the cloth pieces together to provide a prolate-spheroidal bag structure having an opening and a configuration matching that of the inflatable bladder; inserting the inflatable bladder into the prolate-spheroidal bag structure via the opening thereof; and sewing or binding up the opening.

According to a further preferred embodiment of the present invention, the steps for forming the yarn layer include preparing a plurality of cloth pieces; and gluing the cloth pieces onto the outer surface of the inflatable bladder in a predetermined manner.

According to a preferred embodiment of the present invention, the steps for gluing the curved panels onto the outer surface of the ball bladder include dispensing glue on adjoining edges surrounding the curved panels and on inner surfaces of the curved panels; attaching the curved panels to the outer surface of the glue layer to form the prolate-spheroidal structure; and gluing the lacing-shaped patch to a seam between two adjoining curved panels.

According to another preferred embodiment of the present invention, the steps for gluing the curved panels onto the outer surface of the ball bladder include dispensing glue on adjoining edges surrounding the curved panels; connecting the curved panels in pairs along the adjoining edges thereof to provide two half-prolate-spheroidal panels; gluing the lacing-shaped patch to a seam on one of the two half-prolate-spheroidal panels; applying glue on inner surfaces and adjoining edges of the two half-prolate-spheroidal panels, one of which has the lacing-shaped patch glued thereto while the other not; and attaching the two half-prolate-spheroidal panels to the outer surface of the glue layer to provide the prolate-spheroidal structure.

The present invention has the following advantages: (1) panels for forming the football are bent and curved into a desired shape in advance and are then attached to the outer surface of the ball bladder by gluing, enabling largely reduced bad yield and avoiding uncontrollable man-made factors in the process of manufacturing to largely upgrade the production efficiency; (2) the football manufactured according to the present invention has a ball body with increased smoothness; and (3) there is not any sewed edges existing between the panels and the bladder, and a yarn layer is provided on the ball bladder, making the produced football more durable for use.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 illustrates the procedures for manufacturing a conventional football;

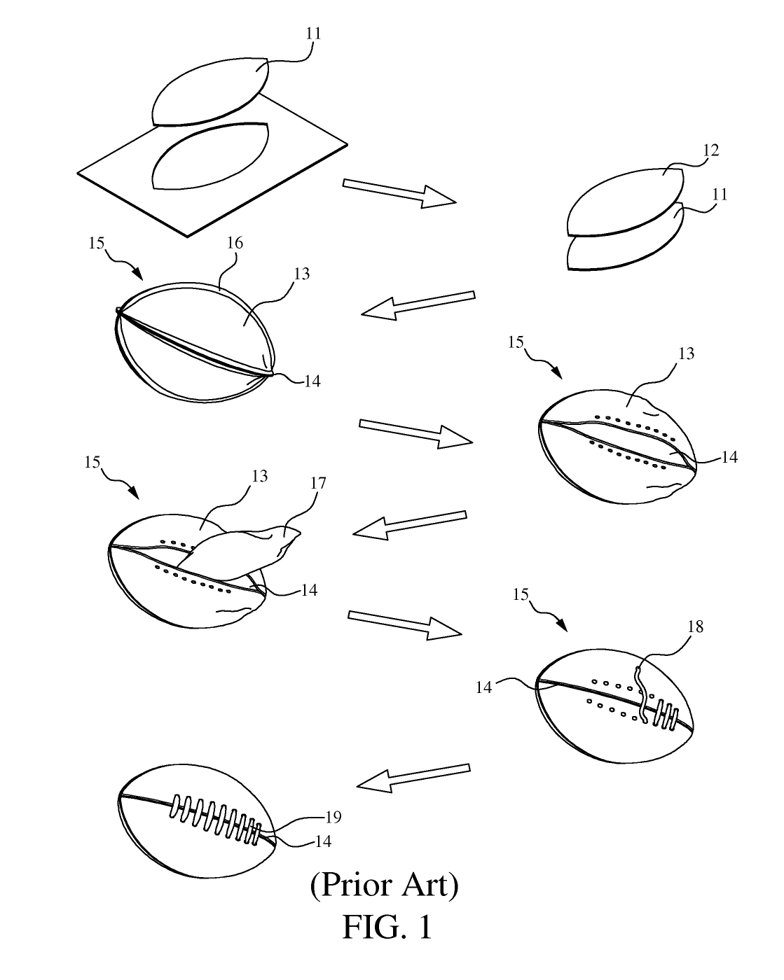

FIG. 2 is a cross-sectional view of the conventional football manufactured according to the procedures shown in FIG. 1;

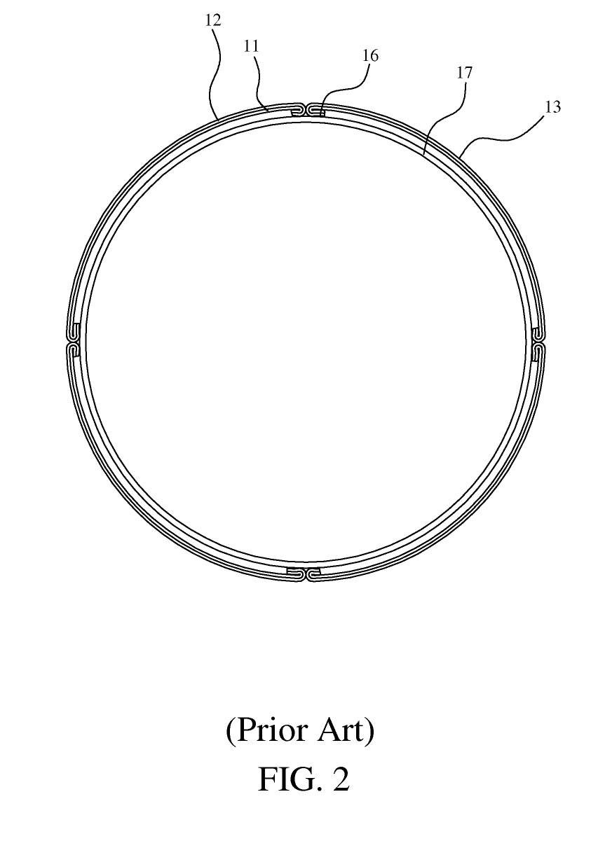

FIG. 3 is an exploded perspective view of a stitch-free football structure according to an embodiment of the present invention;

FIG. 4 illustrates a first preferred embodiment of a curved panel structure for the stitch-free football structure of the present invention;

FIG. 5 shows a first preferred embodiment of attaching a plurality of the curved panels of FIG. 4 to an outer surface of a ball bladder for the stitch-free football structure of the present invention;

FIG. 6 illustrates a second preferred embodiment of a curved panel structure for the stitch-free football structure of the present invention;

FIG. 7 shows a second preferred embodiment of attaching a plurality of the curved panels of FIG. 6 to the outer surface of the ball bladder for the stitch-free football structure of the present invention;

FIG. 8 illustrates the flow of manufacturing a stitch-free football structure according to a method of the present invention;

FIG. 9 illustrates the flow of producing the curved panel for the stitch-free football structure of the present invention;

FIGS. 10A to 10C illustrate different manners of forming a yarn layer on the outer surface the bladder for the stitch-free football structure of the present invention;

FIG. 11 shows a first preferred manner of gluing the curved panels to the outer surface of the ball bladder for the stitch-free football structure of the present invention; and

FIG. 12 illustrates a second preferred manner of gluing the curved panels to the outer surface of the ball bladder for the stitch-free football structure of the present invention.

### DETAILED DESCRIPTION OF THE PREFERRED EMBODIMENTS

The present invention will now be described with some preferred embodiments thereof. For the purpose of easy to understand, elements that are the same in the preferred embodiments are denoted by the same reference numerals.

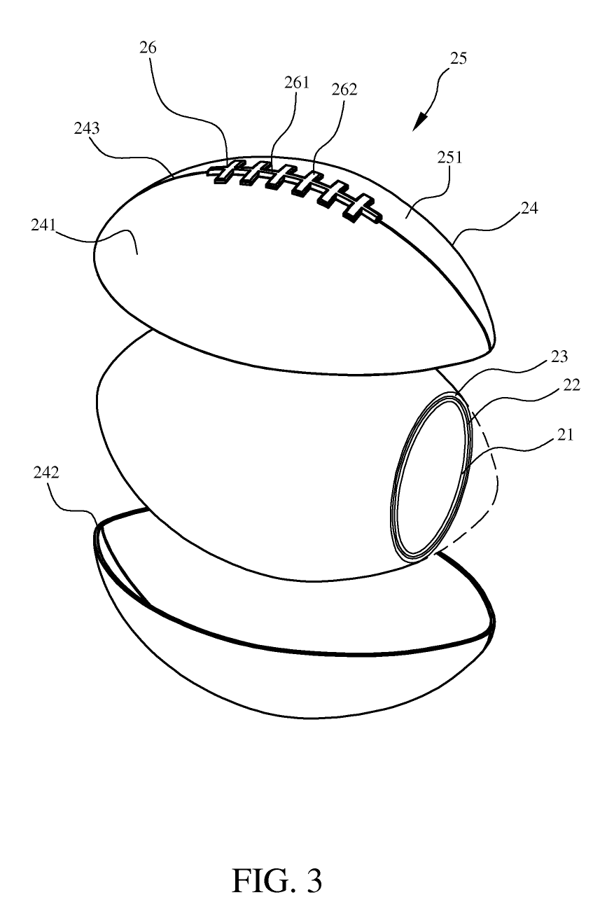

Please refer to FIG. 3. A stitch-free football structure according to the present invention includes an inflatable bladder 21, a yarn layer 22 provided on an outer surface of the inflatable bladder 21, a glue layer 23 formed on an outer side of and permeated into the whole yarn layer 22 using an emulsion or polyurethane (PU), and a prolate-spheroidal structure 25 glued to an outer side of the glue layer 23 and being formed by a plurality of adjoining curved panels 24. In the embodiment illustrated in FIG. 3, four quarter-prolate-spheroidal curved panels 24 are glued to the outer surface of the glue layer 23. Each of the curved panels 24 is a curved piece 241 having a curvature corresponding to a configuration of the inflatable bladder 21. The curved pieces 241 are joined along adjoining edges 242 thereof using a gluing material to thereby form a stitch-free prolate-spheroidal structure 25 without folded and sewed edges. A lacing-shaped patch 26 is glued to one of the seams 243 between any two adjoining curved panels 24 that form the prolate-spheroidal structure 25, so as to meet a required appearance of a football for using in the American football game and to provide a grip for holding. By gluing the lacing-shaped patch 26 to between two adjoining curved panels 24, the time for lacing two adjoining panels 24 together using a thick lace as in the conventional way of forming a football can be saved.

The lacing-shaped patch 26 can be integrally formed by injection-molding or pour-molding to resemble the conventional lacing on a football. That is, the lacing-shaped patch 26 include an elongated main body 261 for extending along the seam 243 and a plurality of parallel branches 262, each of which is symmetrically extended outward from two lateral sides of the main body 261, so as to imitate the lace 18 threaded through perforations along two opposite edges of the lacing hole 14 on the conventional football for the American football game.

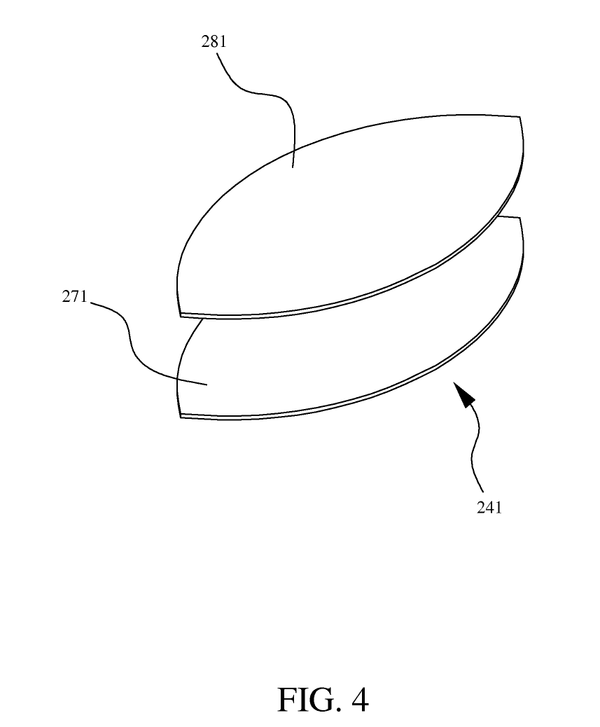

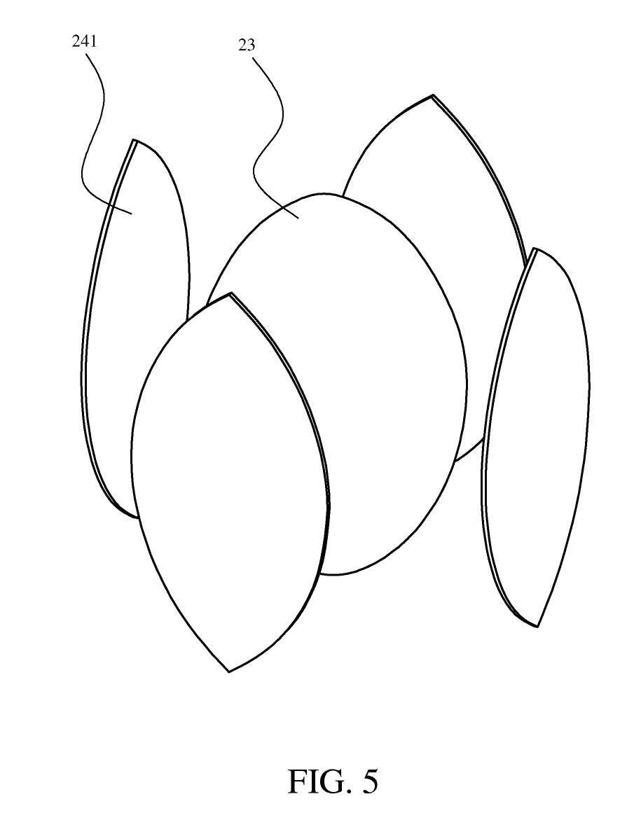

Please refer to FIGS. 4 and 5. According to a first preferred embodiment thereof, each of the curved pieces 241 includes a flat inner layer 271 for contacting with and attaching to the glue layer 23, and a flat outer layer 281 attached to an outer side of the flat inner layer 271. The flat inner layer 271 and the flat outer layer 281 are superposed on and glued to each other, and then bent to form the curved piece 241 having a curvature corresponding to that of the outer surface of the glue layer 23.

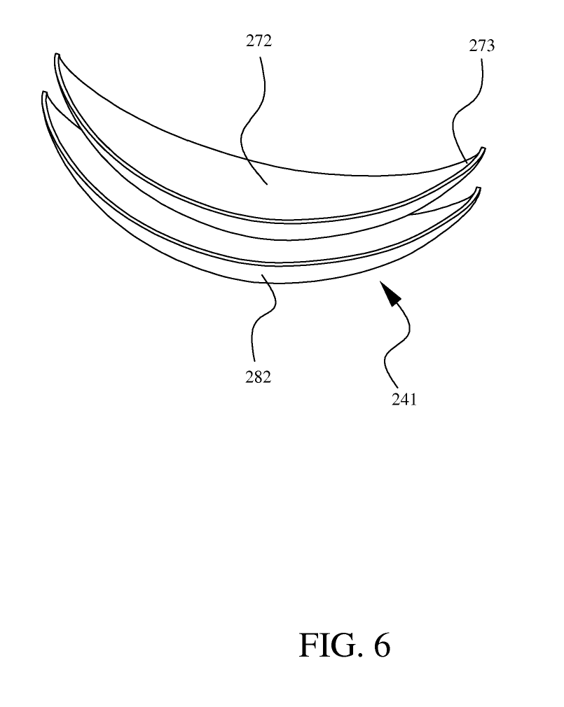

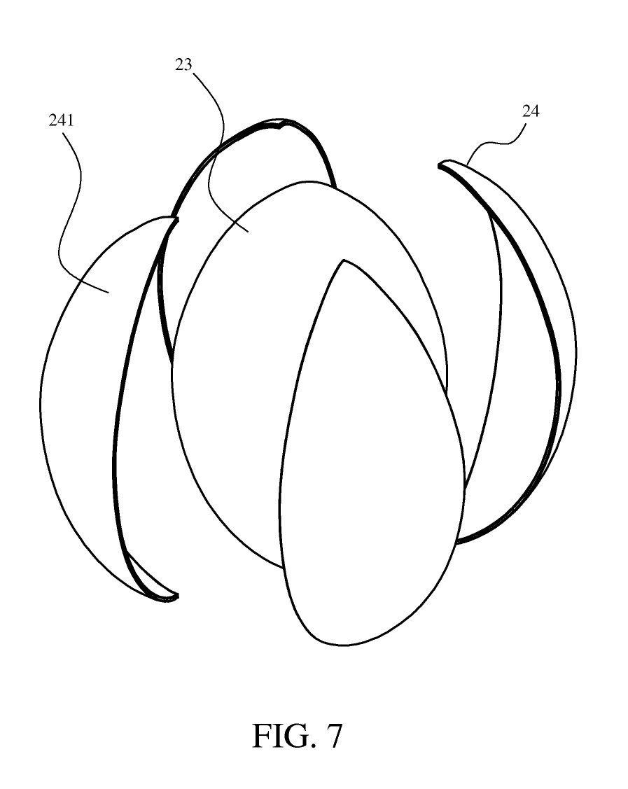

Please refer to FIGS. 6 and 7. According to a second preferred embodiment thereof, each of the curved pieces 241 includes a three-dimensional (3D) inner layer 272 for contacting with and attaching to the glue layer 23 and a 3D outer layer 282. The inner layer 272 is pre-formed by hot-press molding before being assembled to the glue layer 23, so that two opposite pointed ends of the inner layer 272 form two inward bent portions 273. The outer layer 282 is also hot-press molded and is provided on an outer side of the 3D inner layer 272. Thus, the curved piece 241 has a curvature matching that of the glue layer 23 to more fitly and tightly attach to the outer surface of the glue layer 23.

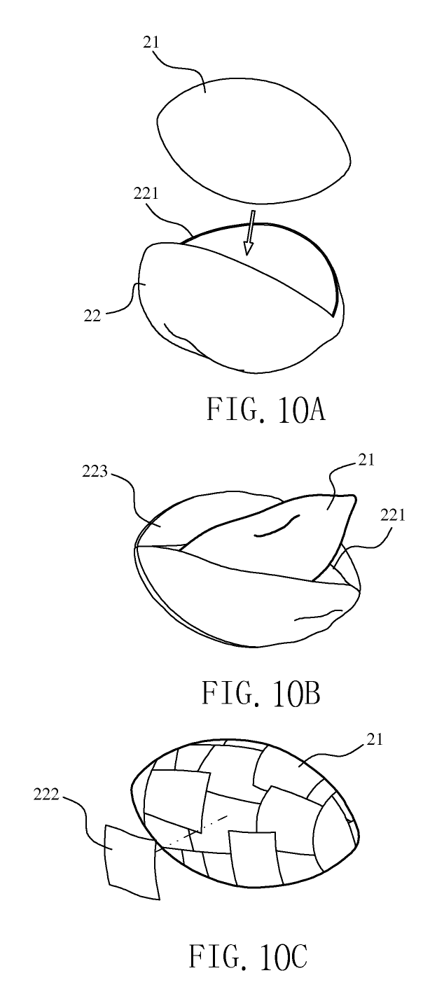

Please refer to FIGS. 10A, 10B and 10C. According to a first embodiment thereof, the yarn layer 22 is formed by knitted synthetic twisted yarns into a substantially prolate-spheroidal net structure, which has a configuration corresponding to that of the inflatable bladder 21 and has an opening 221, as shown in FIG. 10A. According to a second embodiment thereof, the yarn layer 22 is formed by sewing multiple pieces of cloth fabric together to provide a substantially prolate-spheroidal structure corresponding to the configuration of the inflatable bladder 21, as shown in FIG. 10B. And, in a third embodiment thereof, the yarn layer 22 is formed by overlapping and gluing a plurality of relatively small cloth fabric pieces onto the outer surface of the inflatable bladder 21 to provide a substantially prolate-spheroidal structure, as shown in FIG. 10C. The yarn layer 22 is able to give the inflatable bladder 21 with increased surface tensile strength and reduce direct abrasion and impact against the inflatable bladder 21 to thereby enhance the durability of the bladder 21.

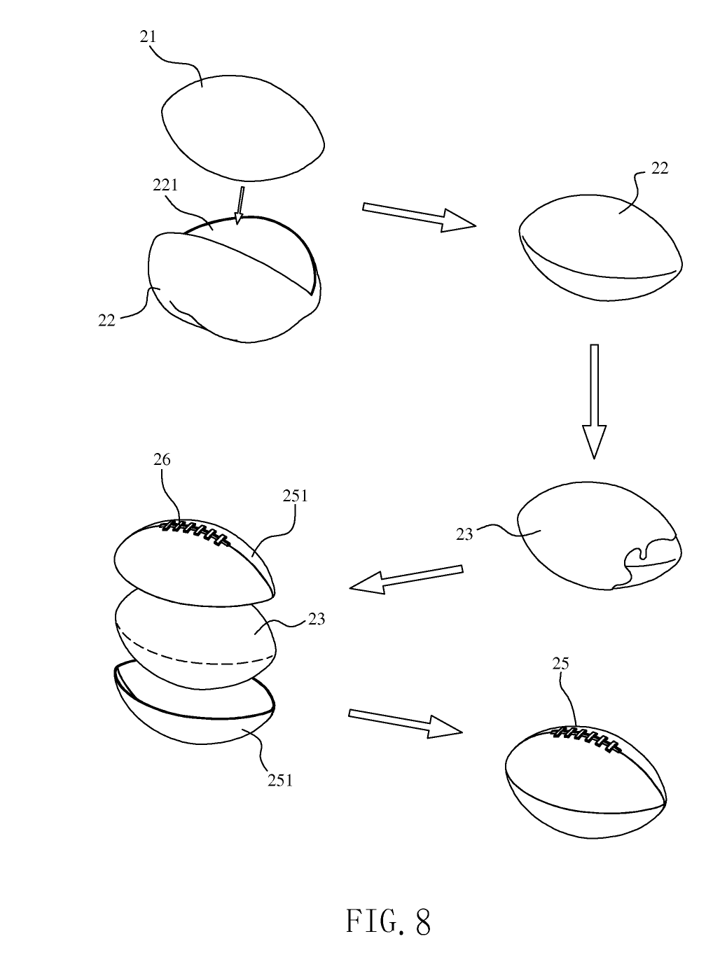

Please refer to FIG. 8, which illustrates steps included in a method of manufacturing a stitch-free football structure according to the present invention.

As shown, to manufacture the stitch-free football structure according to the present invention, first prepare an inflatable bladder 21. Then, form a yarn layer 22 on an outer surface of the inflatable bladder 21 and inflate the bladder 21, so as to set the inflatable bladder 21 and the yarn layer 22 to a required shape for the yarn layer 22 to fully bear on the inflatable bladder 21. Then, evenly apply glue over the yarn layer 22 and allow the glue to fill up all voids in the yarn layer 22 to form a glue layer 23 on an outer side of the yarn layer 22. The glue layer 23 is then heat dried to form a ball bladder 17 having a smooth outer surface. Meanwhile, produce a plurality of curved panels 24 corresponding to the configuration of the inflatable bladder 21 and produce a lacing-shaped patch 26 corresponding to the curvature of the curved panels 24. Then, glue the curved panels 24 to the outer surface of the ball bladder 17, and glue the lacing-shaped patch 26 to one of the seams between two adjoining curved panels 24 to obtain a complete prolate-spheroidal structure 25 for a standard football. And then, position the prolate-spheroidal structure 25 in a heating device to proceed with a ball curvature and shape adjustment procedure, so as to obtain a stitch-free football with high roundness.

The lacing-shaped patch 26 can be integrally formed by injection-molding or pour-molding.

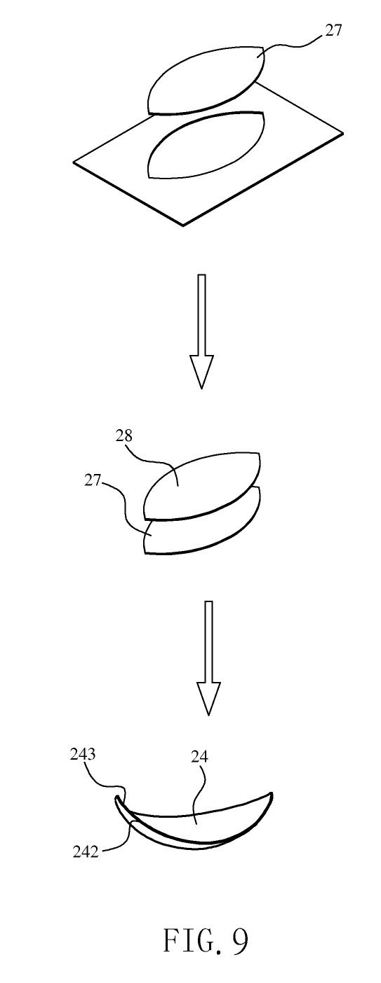

Please refer to FIG. 9. According to an embodiment of the present invention, the steps for producing the curved panel 24 include preparing a cut piece of an inner layer 27 and a cut piece of an outer layer 28 both having a configuration corresponding to that of the inflatable bladder 21; superposing the inner and outer layers 27, 28 on each other; and processing the superposed inner and outer layers 27, 28 into a curved panel 24 matching the curved surface of a standard football. The produced curved panel 24 can be further positioned in a heating device and pressed, so that two opposite pointed ends of the curved panel 24 are suitably bent inward to form a bent portion 273 each.

Please now refer to FIG. 10A. According to a first preferred embodiment of the present invention, the steps for producing the yarn layer 22 include knitting synthetic twisted yarns into a prolate-spheroidal net structure having an opening 221 and a configuration matching that of the inflatable bladder 21; inserting the inflatable bladder 21 into the prolate-spheroidal net structure via the opening 221 thereof; and sewing or binding up the opening 221.

FIG. 10B shows the steps included in a second preferred embodiment of the present invention for producing the yarn layer 22. The steps include preparing cut pieces of cloth 223 corresponding to the configuration of the inflatable bladder 21; sewing the cloth pieces 223 together to provide a prolate-spheroidal bag structure having an opening 221 and a configuration matching that of the inflatable bladder 21; inserting the inflatable bladder 21 into the prolate-spheroidal bag structure via the opening 221 thereof; and sewing or binding up the opening 221.

FIG. 10C shows the steps included in a third preferred embodiment of the present invention for producing the yarn layer 22. The steps include preparing a plurality of small cloth pieces 222; and gluing the small cloth pieces 222 onto the outer surface of the inflatable bladder 21 in a predetermined manner.

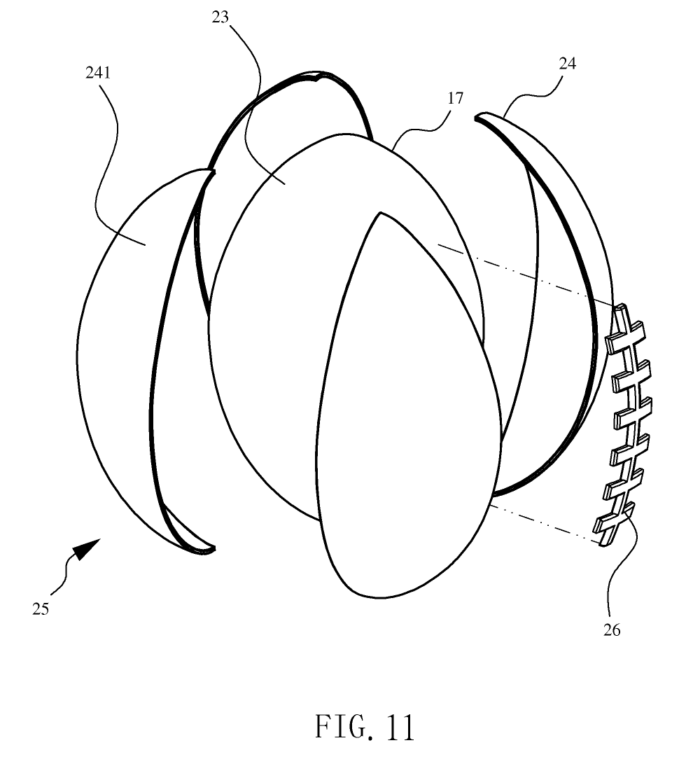

FIG. 11 shows the steps included in a first preferred manner of gluing the curved panels 24 onto the outer surface of the ball bladder 17. The steps include dispensing glue on the adjoining edges surrounding the curved panels 24 and applying glue on inner surfaces of the curved panels 24; and then, attaching the curved panels 24 to the outer surface of the glue layer 23 to form the prolate-spheroidal structure 25; finally, glue the lacing-shaped patch 26 to one of the seams between two adjoining curved panels 24.

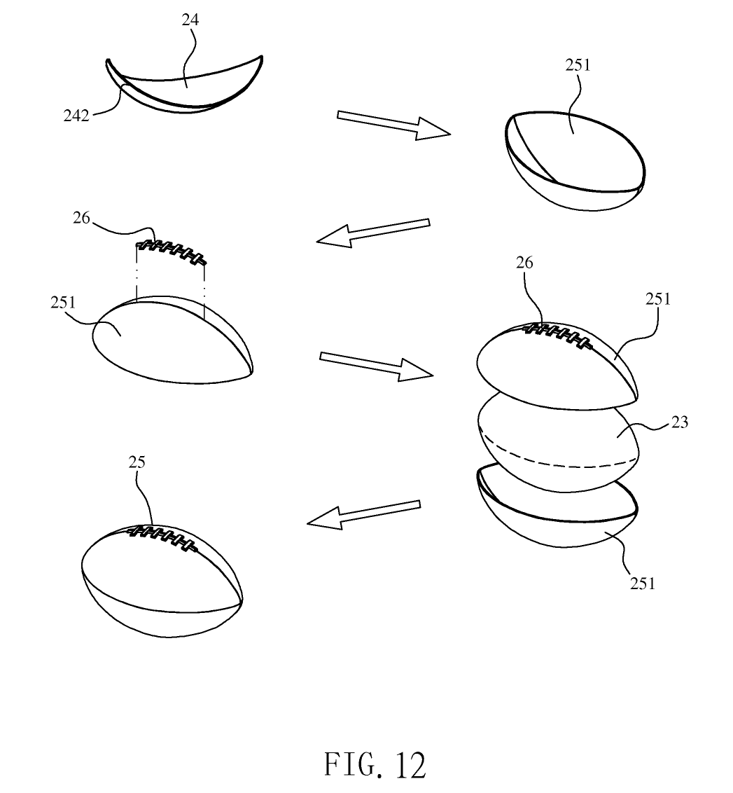

FIG. 12 shows the steps included in a second preferred manner of gluing the curved panels 24 onto the outer surface of the ball bladder 17. The steps include dispensing glue on the adjoining edges 242 surrounding the curved panels 24; then, connecting the curved panels 24 in pairs along the adjoining edges 242 thereof to form two half-prolate-spheroidal panels 251; gluing the lacing-shaped patch 26 to the seam on one of the two half-prolate-spheroidal panels 251; applying glue on inner surfaces and adjoining edges of the two half-prolate-spheroidal panels 251, one of which has the lacing-shaped patch 26 glued thereto while the other not; and attaching the two half-prolate-spheroidal panels 251 to the outer surface of the glue layer 23 to form the prolate-spheroidal structure 25.

With the present invention, pre-formed curved panels are glued to the outer surface of the ball bladder. By doing this, the football can be manufactured through mechanized production and the procedures for manufacturing football can be largely reduced. Further, the bad yield in the production can also be reduced and the manufactured football can have precise dimensions, beautiful and smooth exterior appearance, as well as more durable overall structure.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A stitch-free football structure, comprising an inflatable bladder, a yarn layer provided on an outer surface of the inflatable bladder, a glue layer provided on an outer side of the whole yarn layer, a prolate-spheroidal structure formed by a plurality of adjoining curved panels and glued to an outer side of the glue layer, and a lacing-shaped patch; wherein the curved panels are curved pieces having a curvature corresponding to a configuration of the inflatable bladder, and the curved pieces are joined along adjoining edges thereof using a gluing material, so that the prolate-spheroidal structure formed by the curved panels is stitch-free; and the lacing-shaped patch is glued to a seam between two adjoining curved panels.

2. The stitch-free football structure as claimed in claim 1, wherein the glue layer is formed using a material selected from the group consisting of an emulsion and polyurethane (PU).

3. The stitch-free football structure as claimed in claim 1, wherein the lacing-shaped patch is integrally formed by a manner selected from the group consisting of injection-molding and pour-molding to resemble a conventional lacing structure on a football.

4. The stitch-free football structure as claimed in claim 1, wherein the curved piece includes a flat inner layer for contacting with and attaching to the glue layer and a flat outer layer attached to an outer side of the inner layer.

5. The stitch-free football structure as claimed in claim 1, wherein the curved piece includes a 3D inner layer for contacting with and attaching to the glue layer and a 3D outer layer attached to an outer side of the inner layer; the 3D inner layer having two opposite pointed ends forming two inward bent portions, and the 3D outer layer being formed by hot press molding.

6. The stitch-free football structure as claimed in claim 1, wherein the yarn layer is a prolate-spheroidal net structure knitted using synthetic twisted yarns and has a configuration corresponding to that of the inflatable bladder.

7. The stitch-free football structure as claimed in claim 1, wherein the yarn layer is a prolate-spheroidal bag structure formed by sewing multiple pieces of cloth fabric together and has a configuration corresponding to that of the inflatable bladder.

8. The stitch-free football structure as claimed in claim 1, wherein the yarn layer is a prolate-spheroidal structure formed by gluing a plurality of cloth fabric pieces onto the outer surface of the inflatable bladder.

9. A method of manufacturing a stitch-free football structure as claimed in claim 1, comprising the following steps:
producing an inflatable bladder matching the shape of a football;
forming a yarn layer on an outer surface of the inflatable bladder and inflating the bladder, so as to set the inflatable bladder and the yarn layer to a required shape for the yarn layer to fully bear on the inflatable bladder;
evenly applying glue over the whole yarn layer and allowing the glue to fill up all voids in the yarn layer and form a glue layer, and heat-drying the glue layer to form a ball bladder having a smooth outer surface;
producing a plurality of curved panels corresponding to the configuration of the ball bladder, and producing a lacing-shaped patch corresponding to a curvature of the curved panels;
gluing the curved panels to the outer surface of the ball bladder, and gluing the lacing-shaped patch to a seam between two adjoining curved panels to obtain a complete prolate-spheroidal structure; and
positioning the prolate-spheroidal structure in a heating device to proceed with a ball curvature and shape adjustment procedure, so as to obtain a stitch-free football with high roundness.

10. The method of manufacturing a stitch-free football structure as claimed in claim 9, wherein the lacing-shaped patch is integrally formed by a manner selected from the group consisting of injection-molding and pour-molding.

11. The method of manufacturing a stitch-free football structure as claimed in claim 9, wherein each of the curved panels is produced by preparing a cut piece of an inner layer and a cut piece of an outer layer both having a configuration corresponding to that of the inflatable bladder; superposing the inner and the outer layer on each other; and processing the superposed inner and outer layers to produce the curved panels matching the curved shape of the football.

12. The method of manufacturing a stitch-free football structure as claimed in claim 11, wherein, in producing the curved panels, further includes the step of positioning the curved panels in a heating device and pressing the curved panels, so that two opposite pointed ends of the curved panels form two inward bent portions.

13. The method of manufacturing a stitch-free football structure as claimed in claim 9, wherein the yarn layer is formed by knitting synthetic twisted yarns into a prolate-spheroidal net structure having an opening and a configuration matching that of the inflatable bladder; inserting the inflatable bladder into the prolate-spheroidal net structure via the opening thereof; and sewing or binding up the opening.

14. The method of manufacturing a stitch-free football structure as claimed in claim 9, wherein the yarn layer is formed by preparing a plurality of cut pieces of cloth having a configuration corresponding to that of the inflatable bladder; sewing the cloth pieces together to provide a prolate-spheroidal bag structure having an opening and a configuration matching that of the inflatable bladder; inserting the inflatable bladder into the prolate-spheroidal bag structure via the opening thereof; and sewing or binding up the opening.

15. The method of manufacturing a stitch-free football structure as claimed in claim 9, wherein the yarn layer is formed by preparing a plurality of cloth pieces; and gluing the cloth pieces onto the outer surface of the inflatable bladder in a predetermined manner.

16. The method of manufacturing a stitch-free football structure as claimed in claim 9, wherein the steps for gluing the curved panels onto the outer surface of the ball bladder include dispensing glue on adjoining edges surrounding the curved panels and on inner surfaces of the curved panels; attaching the curved panels to the outer surface of the glue layer to form the prolate-spheroidal structure; and gluing the lacing-shaped patch to the seam between two adjoining curved panels.

17. The method of manufacturing a stitch-free football structure as claimed in claim 9, wherein the steps for gluing the curved panels onto the outer surface of the ball bladder include dispensing glue on adjoining edges surrounding the curved panels; connecting the curved panels in pairs along the adjoining edges thereof to provide two half-prolate-spheroidal panels; gluing the lacing-shaped patch to the seam on one of the two half-prolate-spheroidal panels; applying glue on inner surfaces and adjoining edges of the two half-prolate-spheroidal panels, one of which has the lacing-shaped patch glued thereto while the other not; and attaching the two half-prolate-spheroidal panels to the outer surface of the glue layer to provide the prolate-spheroidal structure.
